(19) United States
(12) Patent Application Publication
(10) Pub. No.: US 2025/0356295 A1
(43) Pub. Date: Nov. 20, 2025

(54) SUPPLY CHAIN MANAGEMENT APPARATUS, SUPPLY CHAIN MANAGEMENT METHOD, AND SUPPLY CHAIN MANAGEMENT SYSTEM

(71) Applicant: Hitachi, Ltd., Tokyo (JP)

(72) Inventors: Tsunehiko Baba, Tokyo (JP); Mika Takata, Tokyo (JP); Ken Naono, Tokyo (JP)

(73) Assignee: Hitachi, Ltd., Tokyo (JP)

(21) Appl. No.: 19/077,373

(22) Filed: Mar. 12, 2025

(30) Foreign Application Priority Data
May 20, 2024 (JP) 2024-081953

(51) Int. Cl. G06Q 10/0635; G06Q 10/087

(52) U.S. Cl. CPC G06Q 10/0635; G06Q 10/087

(57) ABSTRACT

Provided are a supply chain management apparatus, a supply chain management method, and a supply chain management system that make it possible to more accurately assess risks to a supply chain by assessing the risks to the supply chain according to data sources that are more significant for each user. The supply chain management apparatus includes a data read section and a priority data extraction section. The data read section acquires data sources as data related to risks that affect a supply chain. The priority data extraction section selects target data for assessing the risks from the data sources according to significance of the data sources and user's acceptance of the data sources and assesses the risks to the supply chain according to the target data.

### BACKGROUND OF THE INVENTION

### 1. Field of the Invention

The present invention relates to a supply chain management apparatus, a supply chain management method, and a supply chain management system. In particular, the present invention relates, for example, to a supply chain management apparatus that is able to assess risks to a supply chain.

### 2. Description of the Related Art

In recent years, the globalization of corporate activities has created a demand for resilience to deal with a wide variety of risks. For strengthening the supply chain, there is a demand to visualize the entire supply chain and recognize the risks.

JP-2004-511842-T describes a system and a method for sharing and manipulating supply chain data by assigning attributes to the supply chain data and creating hierarchies, calendars, filters, and freeze profiles. Data manipulation can be achieved by assignment, integration, and transformation through the use of predefined relations and rules. Selective sharing of data can be achieved by predefined partnerships and filters. System users are allowed to selectively view the data in a customized and desired format.

JP-2016-99471-A describes an information extraction support apparatus that includes a first acquisition section, a determination section, a selection section, and an extraction section. The first acquisition section acquires a document from which an attribute indicating a desired type of information can be extracted as an analysis target. The determination section determines whether the attribute is valid, and obtains attributes determined to be valid as attribute candidates. The selection section selects an attribute to be used for analysis from the attribute candidates as a selected attribute. The extraction section extracts an expression belonging to the selected attribute from the document as an attribute expression.
Patent Literature 1: JP-2004-511842-A
Patent Literature 2: JP-2016-99741-A

### SUMMARY OF THE INVENTION

The risks to the supply chain in need of consideration vary depending on company characteristics, such as business type, regional characteristics, and company size. Hence, risk assessment to match the characteristics of each company needs to be made from a wide variety of data sources. Meanwhile, it should be noted that a plurality of data sources (e.g., observation points or news) are available even for the same event (e.g., weather or incident). Hence, the results of judgment vary depending on which data source is used for risk assessment.

The present invention aims to provide a supply chain management apparatus, a supply chain management method, and a supply chain management system that make it possible to more accurately assess risks to a supply chain by assessing the risks to the supply chain according to data sources that are more significant for each user.

In order to solve the above problems, a supply chain management apparatus provided by the present invention includes a data acquisition section that acquires data sources as data related to risks that affect a supply chain, a target data selection section that selects target data for assessing the risks from the data sources according to significance of the data sources and user's acceptance of the data sources, and a risk assessment section that assesses the risks to the supply chain according to the target data. In the above-described case, it is possible to provide the supply chain management apparatus that is able to more accurately assess the risks to the supply chain by assessing the risks to the supply chain according to the data sources that are more significant for each user.

In the above instance, for example, the significance of the data sources and the user's acceptance of the data sources are expressed by weights that are defined for the data sources. In this case, it becomes easier to express the degrees of the significance of the data sources and the user's acceptance of the data sources.

Also, for example, the target data selection section selects, as the target data, items corresponding to the user's acceptance that have a large weight expressing the significance of the data sources, from among the data sources. In this case, it is possible to select data sources that are important for each user.

Moreover, for example, the weight expressing the significance of the data sources and the weight expressing the user's acceptance each represent a proportion of the data sources that contain descriptions related to predetermined keywords. In this case, the weights can be set more easily.

Further, for example, the user's acceptance expresses, as priority, the weight of items that are considered to be important, among the data sources. In this case, the data sources important for users can be selected according to the priority.

Furthermore, for example, the risk assessment section assesses the risks to the supply chain according to a score calculated from the weights. In this case, it becomes easier to assess the risks.

Still further, for example, the risk assessment section corrects the score according to feedback inputted by the users as the user's assessment of the assessment of the risks to the supply chain. In this case, it becomes possible to calculate the score adjusted for each user.

In addition, a supply chain management method provided by the present invention causes a processor to execute a program recorded in a memory. The supply chain management method includes acquiring data sources as data related to risks affecting a supply chain, selecting target data for assessing the risks from the data sources according to significance of data sources and the user's acceptance of the data sources, and assessing the risks to the supply chain according to the target data. In the above-described case, it is possible to provide the supply chain management method that is able to more accurately assess the risks to the supply chain by assessing the risks to the supply chain according to the data sources that are more significant for each user.

Also, a supply chain management system provided by the present invention includes a supply chain management apparatus that assesses risks to a supply chain, and a visualization apparatus that visualizes the risks to the supply chain. The supply chain management apparatus includes a data acquisition section that acquires data sources as data related to the risks affecting the supply chain, a target data selection section that selects target data for assessing the risks from the data sources according to significance of the data sources and user's acceptance of the data sources, and a risk assessment section that assesses the risks to the supply chain according to the target data. In the above-described case, it is possible to provide the supply chain management system that is able to more accurately assess the risks to the supply chain by assessing the risks to the supply chain according to the data sources that are more significant for each user.

In the above-described instance, for example, the visualization apparatus displays points that may affect the supply chain and also displays the assessment of the risks to the supply chain in association with the points. In this case, the users are able to recognize the risks associated with the points that may affect the supply chain.

Further, for example, the visualization apparatus receives, as feedback, the user's assessment of the assessment of the risks to the supply chain. In this case, it becomes possible to calculate the score adjusted for each user.

The present invention makes it possible to provide the supply chain management apparatus, the supply chain management method, and the supply chain management system that are able to more accurately assess the risks to the supply chain by assessing the risks to the supply chain according to the data sources that are more significant for each user.

### BRIEF DESCRIPTION OF THE DRAWINGS

FIG. 1 is a block diagram illustrating an overall configuration of a supply chain management system according to an embodiment of the present invention;

FIG. 2 is a diagram illustrating an example of a data characteristics table;

FIG. 3 is a diagram illustrating examples of user-specific priority definition tables;

FIG. 4 is a flowchart illustrating an operation of a priority data extraction section;

FIG. 5 is a diagram illustrating how the priority data extraction section calculates a risk score in step S404 of FIG. 4;

FIG. 6 is a flowchart illustrating an operation of a data characteristics assessment section;

FIG. 7 is a flowchart illustrating details of a process that is performed by the data characteristics assessment section to calculate weights in step S604 of FIG. 6;

FIG. 8 is a flowchart illustrating an operation of a user-specific priority management section;

FIG. 9 is a flowchart illustrating an operation of an extracted data display section; and

FIGS. 10A through 10C are diagrams that illustrate processing results displayed by the extracted data display section.

### DESCRIPTION OF THE PREFERRED EMBODIMENTS

Embodiments of the present invention will now be described in detail with reference to the accompanying drawings.

### <Overview of Supply Chain Management System 1>

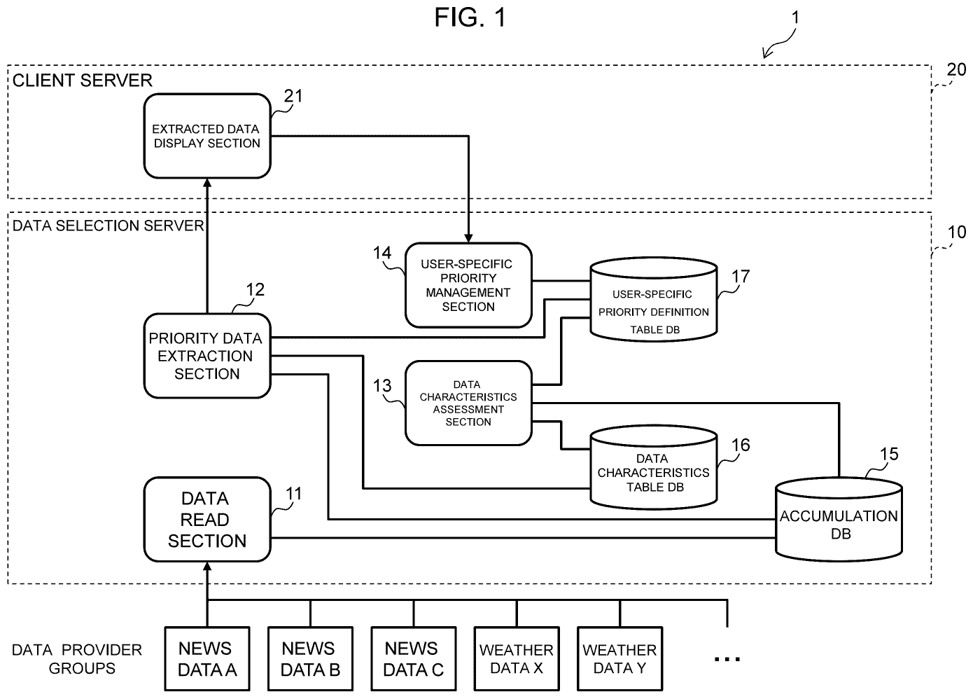

FIG. 1 is a block diagram illustrating an overall configuration of a supply chain management system 1 according to an embodiment of the present invention.

The supply chain management system 1 depicted in FIG. 1 includes a data selection server 10 and a client server 20.

The data selection server 10 is an example of a supply chain management apparatus and assesses risks to a supply chain. In this case, the data selection server 10 assesses the risks to the supply chain, and outputs a processing result to the client server 20.

The data selection server 10 includes a data read section 11, a priority data extraction section 12, a data characteristics assessment section 13, a user-specific priority management section 14, an accumulation database (DB) 15, a data characteristics table DB 16, and a user-specific priority definition table DB 17.

The data read section 11 is an example of a data acquisition section and acquires data sources as data related to the risks that affect the supply chain. Here, the data read section 11 uses, for example, data provider groups to collect the data sources that affect the supply chain. The data provider groups provide, for example, data such as trade statistics, news from news media, and weather data in the form, for instance, of a web service. FIG. 1 indicates a situation, for example, where news data A, news data B, news data C, weather data X, weather data Y, and the like are acquired from the data provider groups. The data read section 11 checks updates to such data sources, acquires necessary data sources, and stores the acquired data sources in the accumulation DB 15.

The priority data extraction section 12 is an example of a target data selection section that selects target data, which is used to assess the risks, from the data sources according to the significance of the data sources and the user's acceptance of the data sources. Further, the priority data extraction section 12 is an example of a risk assessment section that assesses the risks to the supply chain according to the target data.

The “significance of the data sources” indicates the reliability and plausibility of the data sources. It can also be said that the significance indicates whether the quality of the data sources is high or not. In the present embodiment, as will be described in detail later, the significance of the data sources is expressed by weights defined for the data sources. The significance of the data sources is summarized in a data characteristics table (Table 1), which will be described in detail later, and stored in the data characteristics table DB 16.

The “user's acceptance” indicates the values of the data sources to users. It can also be said that the user's acceptance represents characteristics for determining that the data sources are significant for the users. Further, for the supply chain, it can also be said that the user's acceptance represents an item of the data sources that is considered to be important by the users. Furthermore, it can also be said that the user's acceptance represents an item of the data sources that affects the supply chain and is considered to be a priority by the users. In the present embodiment, as will be described in detail later, the user's acceptance is expressed by weights that are defined for the data sources on the basis of a priority that is initially specified by the users. The user's acceptance is summarized in user-specific priority definition tables (Tables 2a to 2d), which will be described in detail later, and is stored in the user-specific priority definition table DB 17. Since the user's acceptance varies from one user to another, the user-specific priority management section 14 manages the user-specific priority definition tables on an individual user basis.

Moreover, the priority data extraction section 12, as will be described in detail later, assesses the risks to the supply chain by using a score calculated from the weights. The score may hereinafter be referred to as the “risk score.” The risk score represents the degree of risk to the supply chain. In the present invention, the higher the risk score, the higher the risk.

The data characteristics assessment section 13 calculates the weights of the characteristics of the data sources for which the priority is specified by the users. Subsequently, the data characteristics assessment section 13 updates the data characteristics table, which is a list summarizing the weights.

The user-specific priority management section 14 manages the user-specific priority definition tables, which will be described in detail later. The user-specific priority management section 14 updates the user-specific priority definition tables for correcting the above-mentioned risk score according to feedback inputted by the users. That is, an extracted data display section 21 of the client server 20 presents the risk score for the supply chain which is determined by the data selection server 10, to the users as a processing result. In this instance, the users are allowed to further assess the processing result. The results of such assessment are returned to the data selection server 10 as the feedback. Subsequently, the user-specific priority management section 14 corrects the user-specific priority definition table (later-described Table 2d) according to the returned results.

The client server 20 is an example of a visualization apparatus that visualizes the risks to the supply chain and is configured to run an application for visualizing the processing results outputted from the data selection server 10, to thereby present the visualized processing results to the users. The users are able to view the results of processing of the risks to the supply chain on the screen of a browser running on terminal devices owned by the users.

The client server 20 includes the extracted data display section 21. The extracted data display section 21 visualizes the processing results by using an application and thus creates an image to be presented to the users.

The data selection server 10 and the client server 20 are computing devices and used here as server computers. However, these servers are not limited to such computing devices, and may alternatively be, for example, personal computers (PCs), mobile computers, smartphones, or tablet computers.

The data selection server 10 and the client server 20 each include a processor such as a central processing unit (CPU) serving as arithmetic means, and a main memory serving as storage means. Here, the processor executes various types of software such as an operating system (OS) and applications (application software). The main memory is a storage area for storing various types of software and, for example, data used for executing the software. Further, the data selection server 10 and the client server 20 each include a storage such as a hard disk drive (HDD) or a solid-state drive (SSD) serving as an auxiliary storage device, and a communication interface for communicating with the outside. Furthermore, the data selection server 10 and the client server 20 may each additionally include input devices such as a mouse and a keyboard, and output devices such as a display.

Although the data selection server 10 and the client server 20 are described here as separate devices, they need not necessarily be separate devices. For example, the data selection server 10 and the client server 20 may be integrated into a single device and configured to perform processing. Further, the data selection server 10 and the client server 20 may be configured as separate devices. Furthermore, although the accumulation DB 15, the data characteristics table DB 16, and the user-specific priority definition table DB 17 are described here as separate databases, they need not necessarily be separate databases. For example, such databases may be configured as a single database of the data selection server 10.

### <Description of Data Characteristics Table>

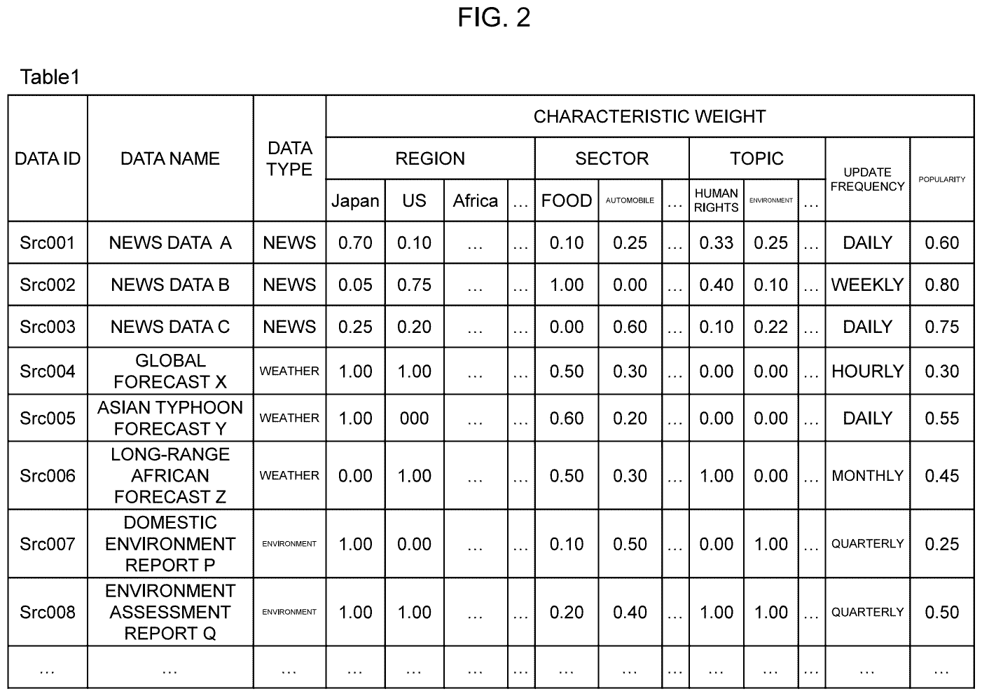

FIG. 2 is a diagram illustrating an example of the data characteristics table.

The data characteristics table (Table 1) depicted in FIG. 2 sets data identification (ID), data name, data type, and characteristics weight (weight) of each data source. Also, the characteristics weight is set for each of the characteristics of region, sector, topic, and popularity. Moreover, an update frequency is the frequency with which the characteristics weight is updated. Daily, weekly, monthly, and quarterly, which are listed as the update frequencies, indicate that the characteristics weight is updated every day, every week, every month, and quarterly, respectively. The characteristics weight is set as a weight for each of these listings. The characteristics weight is a numerical value representing the reliability and plausibility of the data sources. Here, the characteristics weight is expressed by a numerical value between 0 and 1. The higher the numerical value, the higher the reliability and plausibility of the data sources. For example, in the case of a data source with a data ID of Src001, the data name is news data A, and the data type is news. Further, the data characteristics table depicted in FIG. 2 indicates that the characteristics weight of this data source is set to, for example, 0.70 for the Japan region and 0.10 for the United States (US) region.

It is assumed that the characteristics weight is, for example, the proportion of data sources containing the description of a specific keyword, among the data sources. For a region, the keyword is, for example, a place name. If the range of the data sources is, for example, the most recent year, the characteristics weight represents the proportion of data sources in which a specific place name appears within the most recent year. Also, the same is true for sectors and topics. It should be noted that one data source may contain a keyword related to each of region, sector, and topic. In such a case, this keyword is counted for each of region, sector, and topic. For example, in the case of global forecast X with a data ID of Src004, it is assumed that many regions are mentioned. Therefore, 1.00 is listed for a plurality of places as described above. In this case, it can also be said that the weight of the significance of a data source represents the proportion of data sources containing the description of a predetermined keyword.

Further, if the characteristics indicate popularity, the characteristics weight can be expressed by the proportion of users of the supply chain management system 1 that have specified the priority by using the user-specific priority definition tables. For example, if eighty out of one thousand users have specified the priority by using the user-specific priority definition tables at a certain point in time, the characteristics weight is expressed as 0.08. Furthermore, the characteristics weight may be calculated as a numerical value that is obtained in a case where the population parameter is narrowed down on similar users (e.g., users in the same sector and topic).

The characteristics weight is reviewed on a periodic basis indicated as the update frequency. For example, if the update frequency is daily, the characteristics weight is updated every day. This causes the numerical value of the characteristic weight to change over time.

### <Description of User-Specific Priority Definition Tables>

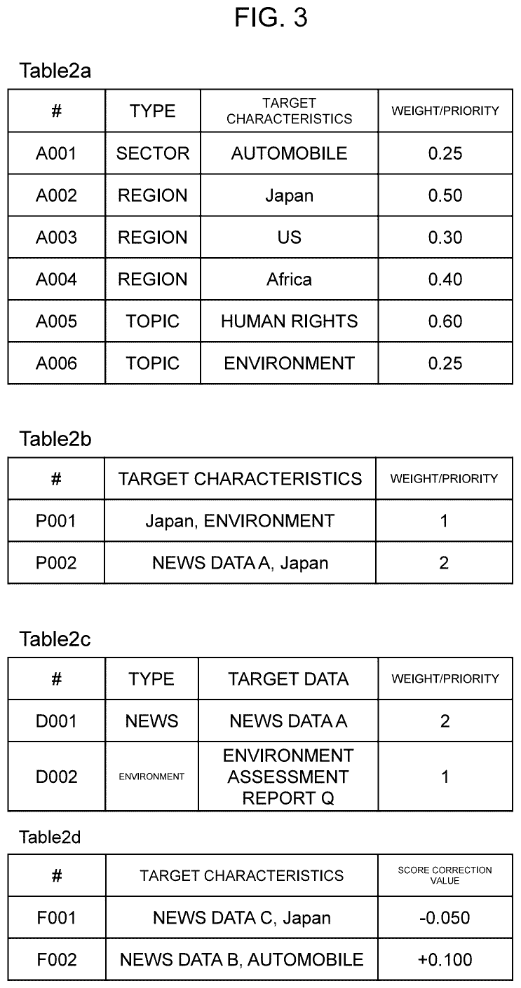

FIG. 3 is a diagram illustrating examples of user-specific priority definition tables.

The user-specific priority definition tables depicted in FIG. 3 are four tables named Tables 2a to 2d. Table 2a is a table in which the weights of the characteristics are set. Here, automobiles, Japan, US, Africa, human rights, and environment are set as the characteristics. For each of these, ID, type, and weight are set. These characteristics correspond to the characteristics listed in FIG. 2, such as region, sector, topic, and popularity. These are characteristics for which a user has specified priority.

The above-mentioned weight can be specified by a numerical value indicating the proportion of data sources in which the characteristics appear. For example, if the characteristics appear in 80% of the data sources, the weight is set to 0.80. Here, the weight is expressed as a numerical value between 0 and 1. The higher the numerical value, the higher the importance to a user. Further, the weight can also be set in place of priority. In such a case, it is assumed that, for example, priority 1 corresponds to 0.80 or higher (80% or higher). Accordingly, it is assumed that data sources with a numerical value equal to or higher than 0.80 are targeted. It should be noted that priority 1 is higher than priority 2. In the case of Table 2a, it can also be said that the weight of user's acceptance represents the proportion of data sources containing the descriptions related to a predetermined keyword.

Table 2b is a table in which the weights of combinations of characteristics and data names are set. Here, ID and weight are set for each combination of characteristics. For example, this table indicates that the priority for the characteristics of the combination of Japan and environment is 1.

Table 2c is a table in which the weights of data names are set. Here, ID, type, and weight are set for each data name. For example, this table indicates that the priority for news data A is 2.

Table 2d is the user-specific priority definition table for correcting the risk score according to feedback inputted by the users. Here, ID and score correction value are set for each combination of characteristics. For example, this table indicates that the score correction value for the characteristics of the combination of news data C and Japan is −0.050.

In the case of Tables 2b to 2d, it can also be said that the user's acceptance is expressed as a priority on the weights of items considered to be important, of data sources.

### <Description of Operation of Priority Data Extraction Section 12>

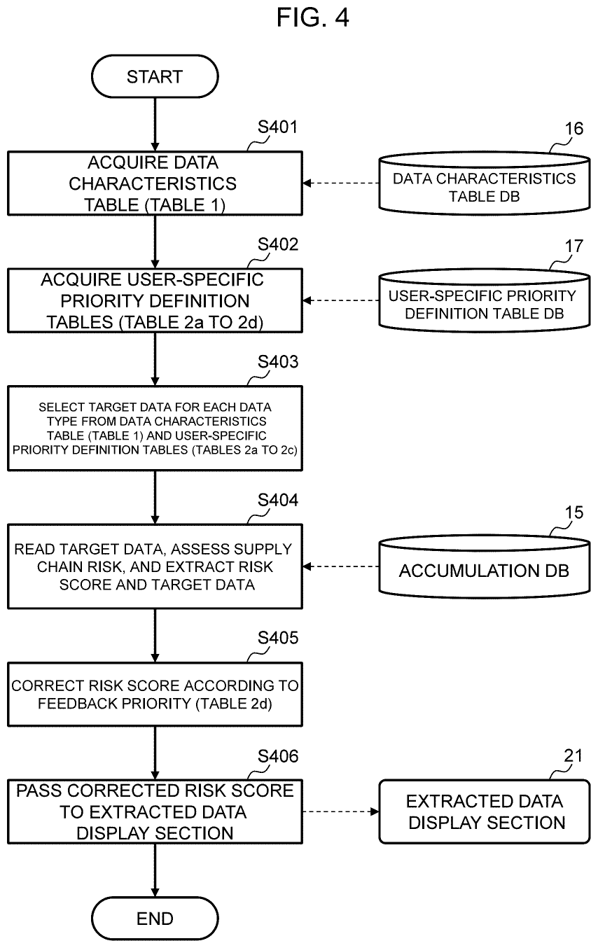

FIG. 4 is a flowchart illustrating an operation of the priority data extraction section 12.

The priority data extraction section 12 acquires the data characteristics table (Table 1) from the data characteristics table DB 16 (step S401).

Next, the priority data extraction section 12 acquires the user-specific priority definition tables (Tables 2a to 2d) from the user-specific priority definition table DB 17 (step 402).

Next, the priority data extraction section 12 selects the target data for assessing the risks for each data type from the data characteristics table (Table 1) and the user-specific priority definition tables (Tables 2a to 2c) (step S403).

Further, the priority data extraction section 12 reads the target data, assesses a supply chain risk, and extracts the risk score and the target data from the accumulation DB 15 (step S404).

Subsequently, the priority data extraction section 12 corrects the risk score according to the user-specific priority definition table (Table 2d) (step S405). In this case, it can also be said that the priority data extraction section 12 corrects the risk score according to feedback inputted by a user, in order to express the user's assessment of the risks to the supply chain. It should be noted that the processing in step S405 can be performed simultaneously with the processing in step S403.

Moreover, the priority data extraction section 12 passes the corrected risk score to the extracted data display section 21 (step S406).

In step S403 of FIG. 4, the priority data extraction section 12 selects the target data, for example, in the following manner. Here, the priority data extraction section 12 selects, as the target data, items corresponding to the user's acceptance that have a large weight expressing the significance of the data sources, from among the data sources. Specifically, the priority data extraction section 12 selects the target data from the data characteristics table (Table 1) by using the data characteristics table (Table 1) depicted in FIG. 2 and the user-specific priority definition tables (Tables 2a to 2c) depicted in FIG. 3. It should be noted that if no perfectly matching data is found, a combination of partially matching data is preferentially selected by the priority data extraction section 12.

For example, the following data IDs are extracted from Table 1 as the data sources that match the definition of target characteristics in Table 2a.
Type is “SECTOR”; matches A001: Src001
Type is “SECTOR”; matches A001 and A002: Src001 and
Src004
Type is “REGION”; matches A002: Src003, Src005, and
Src007
Type is “REGION”; matches A003: Src002 and Src008
Type is “TOPIC”; matches A005 and A006: Src007
Type is “TOPIC”; matches A005: Src001
Type is “TOPIC”; matches A006: Src008

Next, when the definitions of target characteristics in Table 2c are checked, Src001 and Src008 are selected.
Type is “TOPIC”; matches A006: Src008

Further, according to the definitions of target characteristics in Table 2b, the following selection is made.
Matches P001: not available (N/A)
Matches P002: Src001

As a result, the priority data extraction section 12 selects, for example, data sources with data IDs of Src001 and Src008 as the target data.

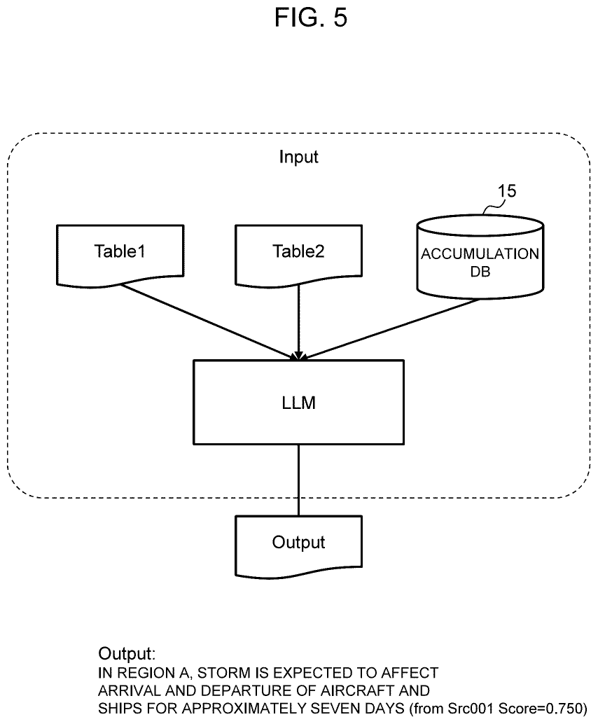

FIG. 5 is a diagram illustrating how the priority data extraction section 12 calculates the risk score in step S404 of FIG. 4.

The priority data extraction section 12 inputs the data characteristics table (Table 1), the user-specific priority definition tables (Tables 2a to 2c), and the data sources stored in the accumulation DB 15, as the Input, to large language models (LLMs). As a result, the LLMs output text as the Output. FIG. 5 depicts, for example, a case where the text “In region A, storm is expected to affect arrival and departure of aircraft and ships for approximately seven days (from Src001, Score=0.750)” is outputted. In the text, “from Src001” indicates that the data ID in the data characteristics table (Table 1) is based on the Src001 data source. Further, “Score=0.750” indicates the risk score in this case.

### <Description of Operation of Data Characteristics Assessment Section 13>

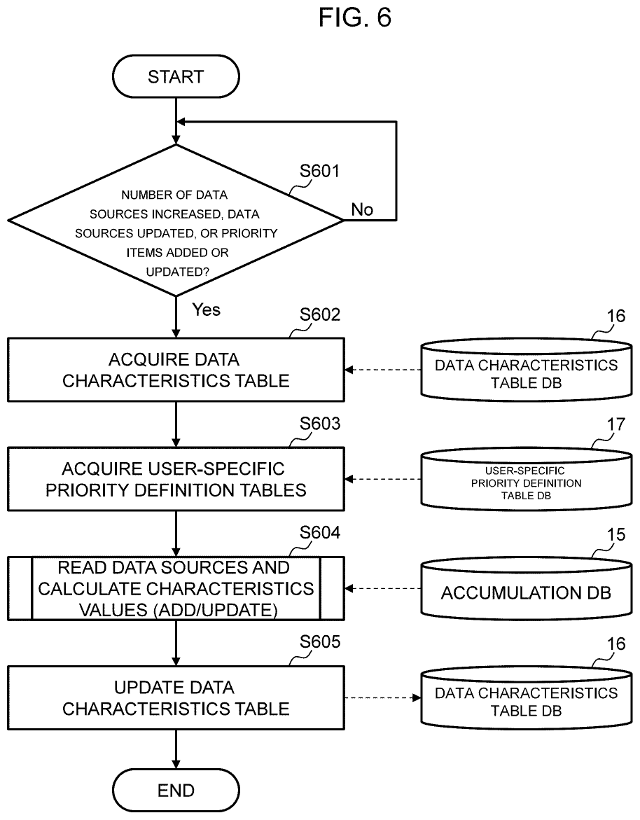

FIG. 6 is a flowchart illustrating an operation of the data characteristics assessment section 13.

First, the data characteristics assessment section 13 determines whether the number of data sources is increased, the data sources are updated, or the items in the user-specific priority definition tables are added or updated (step S601).

Subsequently, if none of the above-mentioned changes are generated (“NO” in step S601), the processing returns to step S601.

Meanwhile, if any of the above-mentioned changes is generated (“YES” in step S601), the data characteristics assessment section 13 acquires the data characteristics table (Table 1) from the data characteristics table DB 16 (step S602).

Next, the data characteristics assessment section 13 acquires the user-specific priority definition tables (Tables 2a to 2d) from the user-specific priority definition table DB 17 (step S603).

Subsequently, the data characteristics assessment section 13 reads the data sources from the accumulation DB 15 and calculates (adds/updates) the weights of the characteristics for which a user has specified priorities, according to the user-specific priority definition tables (step S604).

Further, the data characteristics assessment section 13 updates the data characteristics table (Table 1) (step S605). The updated data characteristics table (Table 1) is stored in the data characteristics table DB 16.

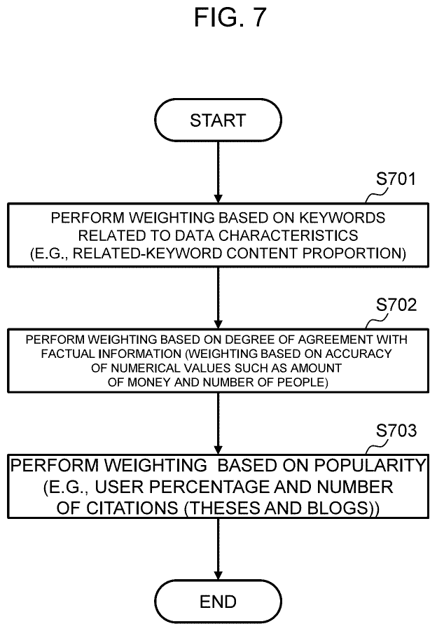

FIG. 7 is a flowchart illustrating the details of a process that is performed by the data characteristics assessment section 13 to calculate the weights in step S604 of FIG. 6.

The data characteristics assessment section 13 performs weighting based on a keyword related to the data characteristics (step S701). It is assumed that weighting based on the proportion of data sources containing the descriptions of a related keyword, among the data sources, is performed.

Next, the data characteristics assessment section 13 performs weighting based on the degree of agreement with factual information (step S702). This weighting can be performed, for example, by comparing the data sources with the factual information and determining the accuracy of numerical values such as the amount of money and the number of people.

Further, the data characteristics assessment section 13 performs weighting based on popularity (step S703). For example, the result of this weighting can be expressed by the proportion of users of the supply chain management system 1 that have specified the priority by using the user-specific priority definition tables. Moreover, if the data sources are, for example, theses or blogs, the result of this weighting can be expressed by the number of citations.

### <Description of Operation of User-Specific Priority Management Section 14>

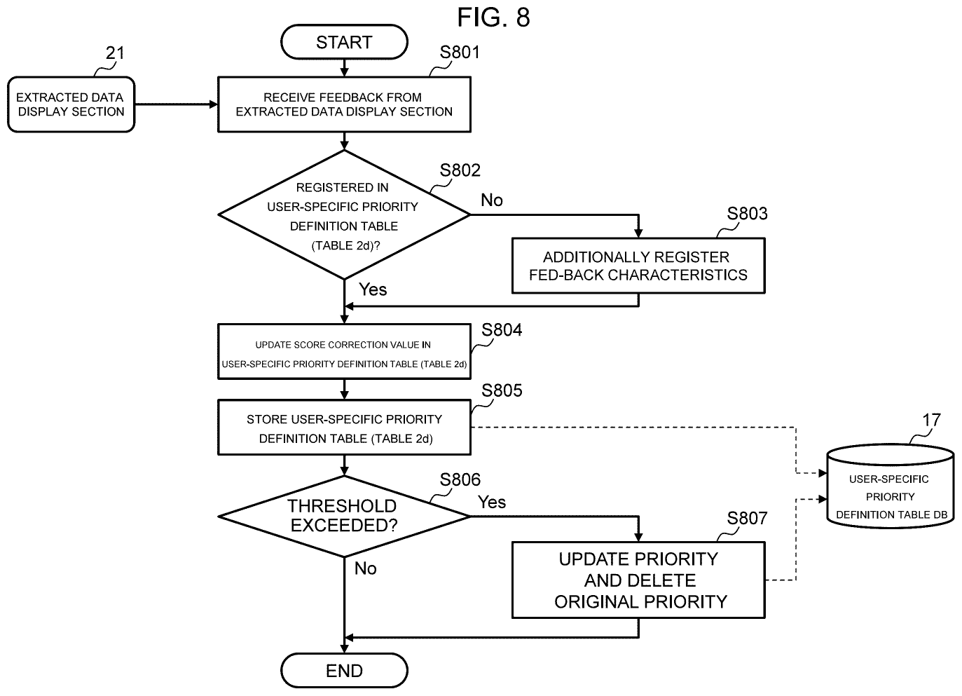

FIG. 8 is a flowchart illustrating an operation of the user-specific priority management section 14.

First, the user-specific priority management section 14 receives feedback which is inputted by a user, from the extracted data display section 21 (step S801).

Next, the user-specific priority management section 14 determines whether the fed-back characteristics are registered in the user-specific priority definition table (Table 2d) (step S802).

If the result of determination indicates that the fed-back characteristics are not registered (“NO” in step S802), the user-specific priority management section 14 additionally registers the fed-back characteristics in the user-specific priority definition table (Table 2d) (step S803).

Meanwhile, if the result of determination indicates that the fed-back characteristics are registered (“YES” in step S802), the user-specific priority management section 14 updates the score correction value in the user-specific priority definition table (Table 2d) (step S804).

Subsequently, the user-specific priority management section 14 stores the user-specific priority definition table (Table 2d) in the user-specific priority definition table DB 17 (step S805).

Further, the user-specific priority management section 14 determines whether a predetermined threshold is exceeded by the priority to be set for the weight (step S806).

If the result of determination indicates that the predetermined threshold is exceeded (“YES” in step S806), the user-specific priority management section 14 updates the priority, and deletes the original priority (step S807). In this instance, the user-specific priority definition tables (Tables 2b and 2c) are updated.

### <Description of Operation of Extracted Data Display Section 21>

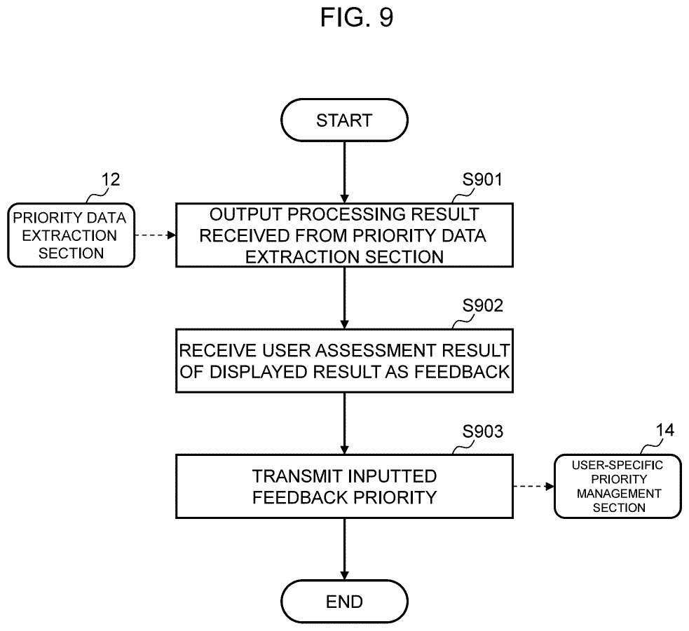

FIG. 9 is a flowchart illustrating an operation of the extracted data display section 21.

The extracted data display section 21 outputs a processing result that is acquired from the priority data extraction section 12 (step S901). This output is generated, for example, by displaying the processing result to a user.

Next, the extracted data display section 21 receives, as the feedback, the result of assessment that is made on the processing result by the user (step S902).

Subsequently, the extracted data display section 21 transmits the result of assessment by the user to the user-specific priority management section 14 (step S903).

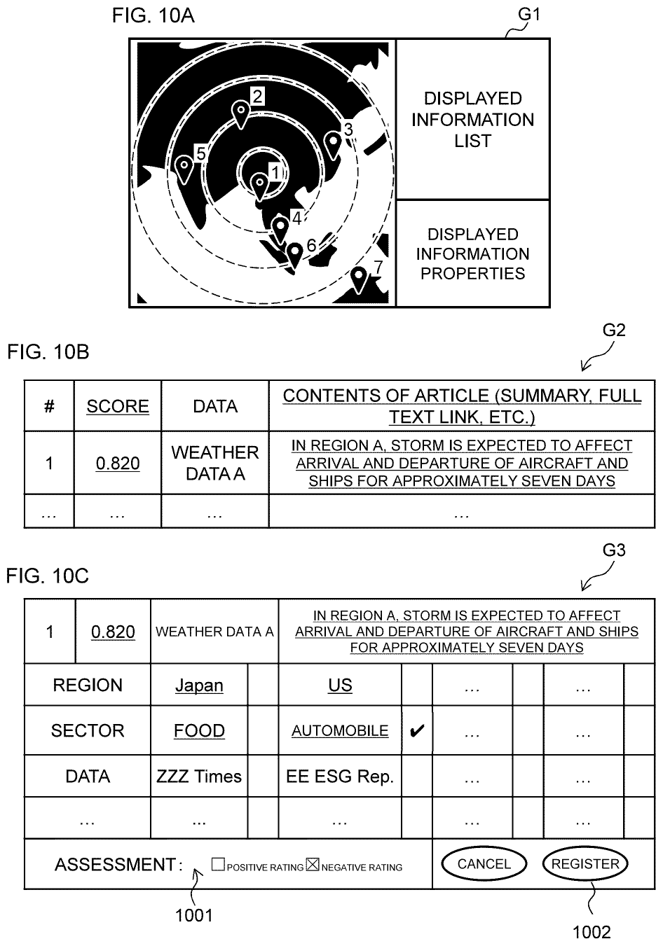

FIGS. 10A through 10C are diagrams that illustrate the processing results displayed by the extracted data display section 21.

FIGS. 10A through 10C each depict an example in which the risk score is visualized and displayed on a screen by the extracted data display section 21.

FIG. 10A depicts a case where a processing result is displayed on a screen G1. A map drawing area is provided on the left side of the screen G1 in the figure to display points that may affect the supply chain. Here, these points are named points 1 to 7.

When the user selects a displayed information list on the upper right side of the screen G1, for example, by clicking the mouse, the screen transitions to a screen G2 depicted in FIG. 10B.

The screen G2 depicts a case where a risk score, a data name, and the contents of an article regarding point 1 are displayed in a tabular form. Here, the screen G2 indicates that the risk score (score) of point 1 is 0.820, and that the data name of a data source on which the calculation of the risk score is based is weather data A. Additionally, the contents affecting the supply chain are displayed as the contents of the article. Here, the article states that “In region A, a storm is expected to affect the arrival and departure of aircraft and ships for approximately seven days.” The contents of the article are based on the text that is outputted as the Output as depicted in FIG. 5.

In the above case, it can be said that the extracted data display section 21 displays the assessment of the risks to the supply chain in association with the points possibly affecting the supply chain.

Further, when the user selects displayed information properties on the lower right side of the screen G1, for example, by clicking the mouse, the screen transitions to a screen G3 depicted in FIG. 10C.

The screen G3 displays the table displayed on the screen G2 and the characteristics for which the risk score is calculated. Here, the screen G3 indicates that the risk score is calculated for a case where the characteristics are automobiles. Additionally, a column for receiving feedback from the user is displayed at the bottom of the screen G3. Here, check boxes 1001 allow the user to select a positive or negative assessment as the assessment made by the user. Further, after checking one of these check boxes, the user can input feedback by pressing a register button 1002.

In the above case, it can also be said that the extracted data display section 21 receives, as feedback, the user's assessment of the risks to the supply chain.

The data selection server 10, which is described in detail above, makes it possible to more accurately assess the risks to the supply chain by assessing the risks to the supply chain according to the data sources that are more significant for each user.

### <Description of Supply Chain Management Method>

The processing performed by the data selection server 10 is implemented when software and hardware sources collaborate. More specifically, a CPU or other processor provided in the data selection server 10 loads a program for implementing each function of the data selection server 10 into the main memory and executes the loaded program to implement each function.

Consequently, the processing performed by the data selection server 10 which is described above can be regarded as a supply chain management method in which the processor executes a program recorded in a memory to acquire data sources as data related to risks affecting the supply chain, selects target data for assessing the risks from the data sources according to the significance of the data sources and the user's acceptance of the data sources, and assesses the risks to the supply chain according to the target data. This makes it possible to provide the supply chain management method that is able to more accurately assess the risks to the supply chain by assessing the risks to the supply chain according to the data sources that are more significant for each user.

Further, the program running on the data selection server 10 can be regarded as a program for causing a computer to implement a function of, by a processor, executing a program recorded in a memory and acquiring data sources as data related to risks affecting a supply chain, a function of selecting target data for assessing the risks from the data sources according to the significance of the data sources and the user's acceptance of the data sources, and assessing the risks to the supply chain according to the target data. This enables the computer to more accurately assess the risks to the supply chain by assessing the risks to the supply chain according to the data sources that are more significant for each user.

It should be noted that the program for implementing the present embodiment can certainly be supplied by means of communications and can also be supplied on a compact disc read only memory (CD-ROM) or other recording medium.

While the present embodiment has been described above, the technical scope of the present invention is not limited to the scope that is described in conjunction with the embodiment described above. It is obvious from the scope of the appended claims that various changes and improvements may be made to the above-described embodiment without departing from the technical scope of the present invention.

What is claimed is:

1. A supply chain management apparatus comprising:
a data acquisition section that acquires data sources as data related to risks that affect a supply chain;
a target data selection section that selects target data for assessing the risks from the data sources according to significance of the data sources and user's acceptance of the data sources; and
a risk assessment section that assesses the risks to the supply chain according to the target data.

2. The supply chain management apparatus according to claim 1,
wherein the significance of the data sources and the user's acceptance of the data sources are expressed by weights that are defined for the data sources.

3. The supply chain management apparatus according to claim 2,
wherein the target data selection section selects, as the target data, items corresponding to the user's acceptance that have a large weight expressing the significance of the data sources, from among the data sources.

4. The supply chain management apparatus according to claim 2,
wherein the weight expressing the significance of the data sources and the weight expressing the user's acceptance each represent a proportion of the data sources that contain descriptions related to predetermined keywords.

5. The supply chain management apparatus according to claim 2,
wherein the user's acceptance expresses, as priority, the weight of items that are considered to be important, among the data sources.

6. The supply chain management apparatus according to claim 2,
wherein the risk assessment section assesses the risks to the supply chain according to a score calculated from the weights.

7. The supply chain management apparatus according to claim 6,
wherein the risk assessment section corrects the score according to feedback inputted by the users as the user's assessment of the assessment of the risks to the supply chain.

8. A supply chain management method of causing a processor to execute a program recorded in a memory, the supply chain management method comprising:
acquiring data sources as data related to risks affecting a supply chain;
selecting target data for assessing the risks from the data sources according to significance of data sources and the user's acceptance of the data sources; and
assessing the risks to the supply chain according to the target data.

9. A supply chain management system comprising:
a supply chain management apparatus that assesses risks to a supply chain; and
a visualization apparatus that visualizes the risks to the supply chain;
wherein the supply chain management apparatus includes
a data acquisition section that acquires data sources as data related to the risks affecting the supply chain,
a target data selection section that selects target data for assessing the risks from the data sources according to significance of the data sources and user's acceptance of the data sources, and
a risk assessment section that assesses the risks to the supply chain according to the target data.

10. The supply chain management system according to claim 9,
wherein the visualization apparatus displays points that may affect the supply chain and also displays the assessment of the risks to the supply chain in association with the points.

11. The supply chain management system according to claim 9,
wherein the visualization apparatus receives, as feedback, the user's assessment of the assessment of the risks to the supply chain.
